(19) United States
(12) Patent Application Publication
(10) Pub. No.: US 2015/0129504 A1
(43) Pub. Date: May 14, 2015

(54) ORGANO-MODIFIED CLAYS FOR REMOVAL OF AQUEOUS RADIOACTIVE ANIONS

(71) Applicant: Savannah River Nuclear Solutions, LLC, Aiken, SC (US)

(72) Inventors: Daniel I. Kaplan, Aiken, SC (US); Anna S. Knox, Evans, GA (US); Kimberly P. Crapse, Aiken, SC (US); Dien Li, Buffalo Grove, IL (US); David P. DiPrete, Evans, GA (US)

(73) Assignee: Savannah River Nuclear Solutions, LLC, Aiken, SC (US)

(21) Appl. No.: 14/080,311

(22) Filed: Nov. 14, 2013

(51) Int. Cl. C02F 1/28

(52) U.S. Cl. CPC C02F 1/281
USPC 210/682

(57) ABSTRACT

Methods are described for the removal of highly soluble radioactive anions, e.g., radioactive technetium and/or radioiodide, from an aqueous solution. The methods utilize a sequestering agent that includes an organoclay, i.e., a clay with an intercalated cationic quaternary amine, as a sorbent for highly soluble radioactive anions that are present within an aqueous solution. In exemplary embodiments, the method can be utilized to treat aqueous waste at a nuclear power facility or to treat a groundwater contamination site or a soil or sediment contaminated site.

### STATEMENT AS TO RIGHTS TO INVENTIONS MADE UNDER FEDERALLY SPONSORED RESEARCH

This invention was made with Government support under Contract No. DE-AC09-08SR22470 awarded by the United States Department of Energy. The Government has certain rights in the invention.

### BACKGROUND

Reprocessing of nuclear waste is commonly used to recover plutonium, uranium, and other useful materials from spent nuclear fuel. Liquid-liquid extraction methods currently in use can extract both uranium and plutonium independently of each other and from other fission products. Unfortunately, while reprocessing methods can extract uranium and plutonium the liquid waste generated still carries many of the fission products and transuranic elements generated in the core.

Of primary concern in the remaining waste are the fission products technetium (Tc-99) and iodine (I-129), which have extremely long half-lives (220,000 years and 15.7 million years, respectively) and eventually dominate human-risk associated with the handling and disposal of spent nuclear fuels. Radioactive technetium and iodine are two of the three (along with carbon 14) most common risk drivers in both low-level and high-level waste disposal sites and among the most common environmental contaminants at nuclear-materials production facilities.

Methods for long-term storage of radioactive technetium and iodine have been developed such as the formation of various types of glass waste forms at the Pacific Northwest National Laboratory and Savannah River Site and the formation of a cementitious waste form (saltstone) at the Savannah River Site. Long-term storage is not the ideal disposal method, however, as these materials presently exist in a highly complex liquid mixture that is also highly toxic and radioactive, it is extremely difficult to recover these isotopes for beneficial purposes and as a result their world-wide inventories are continuously increasing. Compounding the potential threat these radionuclides pose, they are highly mobile in a subsurface environment; moving at about the rate of water. The anionic nature of radioactive technetium and iodine promotes their high mobility in the environment as these materials are highly soluble and do not bind to natural compounds. For example, the Hanford Site in Washington has radioiodine plumes that are greater than 50 square kilometers, with no current proposed method for remediation. The current approach to addressing the contamination plume is to pump the iodine-contaminated groundwater up-gradient to slow the plume growth rate.

In addition to long term storage issues, these radionuclides are also common contaminants following nuclear accidents such as Chernobyl or Fukushima. For example, I-131 (with a half-life of 8 days) exposure resulted in high incidence of thyroid cancer for those who were infants at the time of the Chernobyl disaster.

Methods for removal of radioactive technetium from groundwater include the use of microbes or metallic iron additions. In both processes, the technetium must be reduced from the highly mobile Tc(VII) form to the Tc(IV) form, so as to precipitate the solid. Unfortunately, this reduction is reversible under many environmental conditions, such as if the microbes die or if the iron oxidizes. There also exist some highly effective technetium extraction resins such as TEVA resin (available from TrisKem International, Bruz, France), but this approach is prohibitively expensive, particularly when considering groundwater remediation processes. Furthermore, the reduced Tc(IV) concentrations obtained by microbial and metallic iron additions, while lower than groundwater Tc concentrations, are still well above the Environmental Protection Agency's drinking water Maximum Contaminant Levels (MCL) of 900 pCi/L.

What is needed in the art is a method for recovering radioactive anions from solution, for instance in the treatment of high level active waste or in groundwater remediation.

### SUMMARY

Aspects and advantages of the invention will be set forth in part in the following description, or may be obvious from the description, or may be learned through practice of the invention.

According to one embodiment, disclosed is a method for removing highly soluble radioactive anions from an aqueous solution. The method includes contacting the aqueous solution containing the highly soluble radioactive anions with a sequestering agent. The sequestering agent can include an organoclay that comprises a clay and/or a clay mineral and a cationic quaternary amine as an intercalation within the clay. Through contact of the sequestering agent with the aqueous solution, the radioactive anions can be adsorbed onto the organoclay. The method can be highly efficient, for instance concentrating the radionuclide on the organoclay such that the concentration of the radionuclide on the organoclay is about 5,000 times or more greater than the concentration of the radionuclide in the aqueous solution following contact. In one embodiment, the highly soluble radioactive anions are radioactive technetium and/or radioactive iodine.

### BRIEF DESCRIPTION OF THE FIGURE

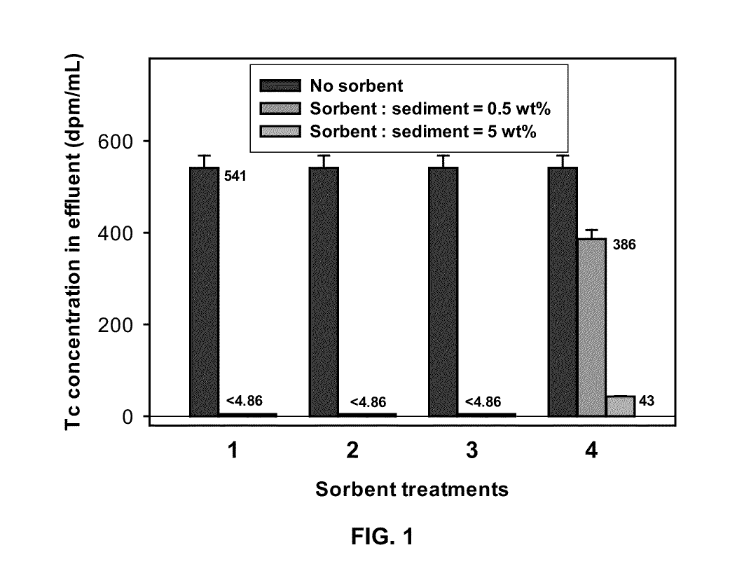

A full and enabling disclosure of the present invention, including the best mode thereof, directed to one of ordinary skill in the art, is set forth in the specification, which makes reference to the appended figures, in which FIG. 1 illustrates the technetium concentration obtained following treatment with various sorbents.

### DETAILED DESCRIPTION

It is to be understood by one of ordinary skill in the art that the present discussion is a description of exemplary embodiments only, and is not intended as limiting the broader aspects of the present disclosure. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

In general, disclosed herein are methods directed to the removal of highly soluble radioactive anions, e.g., radioactive technetium and/or radioiodide, from an aqueous solution. For example, the methods can be utilized to treat aqueous waste at a nuclear power facility or to treat a groundwater contamination site. For instance, disclosed methods can be utilized to treat contaminated soil or sediment. As utilized herein, the term soil generally refers to the unconsolidated mineral or organic material on the immediate surface of the earth that serves as a natural medium for the growth of land plants and encompasses the unconsolidated mineral or organic matter on the surface of the earth that has been subjected to and shows effects of genetic and environmental factors of: climate (including water and temperature effects), and macro- and microorganisms, conditioned by relief, acting on parent material over a period of time. A product-soil differs from the material from which it is derived in many physical, chemical, biological, and morphological properties and characteristics. As utilized herein, the term sediment generally refers to transported and deposited particles or aggregates derived from rocks, soil, or biological material.

In general, the method includes utilization of a sequestering agent that includes an organoclay, i.e., a clay and/or a clay mineral with an intercalated cationic quaternary amine, as a sorbent for highly soluble radioactive anions that are present within an aqueous solution.

The methods are low-cost, relatively simple processes that utilize a highly reactive organoclay for the separation of the radioactive anions from an aqueous source, e.g., an aqueous waste stream. Disclosed methods can be utilized to provide for improved long-term safety in the disposal of nuclear waste, for instance in the subsurface environment in the form of saltstone or a glass waste form, through the removal of technetium and/or iodine from the waste prior to disposal.

The methods can be beneficially utilized for environmental remediation, for example following accidental release of radionuclides into the environment or following release or radionuclides from a weapon of mass effect. In addition, the separation methods can lead to the recovery of useful isotopes, such as medically useful technetium, from sewage, a waste stream, or contamination site.

As utilized herein, the term ‘clay’ generally refers to a naturally occurring material or a synthetic derivative of a naturally occurring material that is composed primarily of fine-grained minerals. A clay is generally plastic at appropriate water content and will harden when dried or fired. While a clay generally contains phyllosilicates, it may contain other materials that impart plasticity and harden when dried or fired. A clay may include associated phases that may include materials that do not impart plasticity and may contain organic matter. The grain size of a clay is not critical and can vary for example about 10 micrometers or less, about 5 micrometers or less, about 4 micrometers or less, about 2 micrometers or less, or about 1 micrometer or less, in various embodiments.

As utilized herein, the term ‘clay mineral’ generally refers to natural or synthetic phyllosilicate minerals and to minerals that impart plasticity to clay and that harden upon drying or firing. Phyllosilicates of any grain size can be considered clay minerals. Clay minerals are not limited to phyllosilicates and any mineral that can impart plasticity to clay and that can harden upon drying or firing is encompassed by the term. For example, an oxy-hydroxide mineral that can exhibit plasticity and hardening upon drying or firing can be considered to be a clay mineral.

Use of the terms ‘clay’ and ‘clay minerals’ has been previously discussed in the art. See, for example, Guggenheim and Martin, Clays and Clay Minerals, Vol. 43, No. 2, 255-256, 1995.

Clays and clay minerals that can be utilized as a substrate for an organic substance to form the organoclay can include, without limitation, any of the hydrous aluminum phyllosilicates that can include various amounts of iron, magnesium, alkali metals, alkaline earth metals, or other cations. The clay or clay mineral is not particularly limited and can include those of the kaolin group, the smectite group, the illite group, the bentonites, or the chlorite group. For instance, the clay can be a 1:1 type clay such as kaolinite or serpentine or a 2:1 clay such as talk, vermiculite, or montmorillonite.

In one embodiment, the clay can be a smectite-type clay including, without limitation, montmorillonite, paligorskite, attapulgite, sepiolite, saponite, kaolinite, halloysite, hectorite, beidellite, nontronite, volkonskoite, sauconite, stevensite, a synthetic smectite derivative (e.g., fluorohectorite, laponite), and combinations thereof. Mixed layered clays are also encompassed herein such as, without limitation, rectorite and synthetic derivatives thereof, vermiculite, illite, micaceous minerals, makatite, kanemite, octasilicate, magadiite, palygorskite, sepoilite, or any combination thereof.

Clay and clay minerals encompassed herein also include aluminosilicate minerals with a cage structure, such as zeolites (also commonly referred to as molecular sieves). Zeolites are microporous phyllosilicate minerals having a porous structure that can accommodate adsorbed ions. Zeolites encompassed herein include, without limitation, analcime, chabazite, clinoptilolite, heulandite, natrolite, phillipsite, and stillbite. Zeolites of any structural group are encompassed herein including the fibrous zeolites (e.g., gonnardite, natrolite, edingtonite, thomsonite, etc.), zeolites including chains of single connected 4-membered rings (e.g., analcime, leucite, laumontite, etc.), zeolites including chains of doubly-connected 4-membered rings (e.g., harmotome, amicite, gismondine, boggsite, etc.), tabular zeolites (e.g., chabazites, faujasites, mordenites, etc.), tetrahedra zeolites (e.g., heulandites, stilbites, brewsterites), and combinations of zeolites.

The organoclay includes one or more organic compounds substituted for cations of the clay or clay mineral. The substituted organic compound(s) can be substituted within the individual layers of the clay, i.e., intercalated, or can be substituted within the pores of a porous clay or clay mineral, e.g., substituted zeolites, and/or can be substituted on the surface of the clay or clay mineral. The organoclay thus includes both the inorganic mineral phase and the organic intercalated phase.

In general, the organic phase can include a cationic quaternary amine. The cationic quaternary amine can have the general structure of:

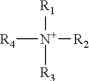

wherein R₁, R₂, R₃, and R₄ are independently hydrogen or hydrocarbon groups including from about 1 to about 24 carbons and that can include linear, branched, and/or aromatic moieties, and that can be substituted or non-substituted, with the proviso that not all of R₁, R₂, R₃, and R₄ are hydrogen.

By way of example, the cationic quaternary amine can include sulfur, iron, or nitrogen-containing substitutions and/or can include functional groups as a component of one or more of R1, R2, R3, and R4 that can provide a desired characteristic to the organoclay such as complexation formation or increased hydrophobicity that can improve adsorption of the targeted radioactive anion. In one embodiment, the cationic quaternary amine can include a sulfur-containing group as at least one of R1, R2, R3, and R4. In general, any suitable quaternary amine compound can be utilized to provide the cationic quaternary amine of the organoclay. For instance, the quaternary amine compound can be a salt of the cation (e.g., a halide, acetate, methylsulfate, or hydroxide salt of a cationic quaternary amine).

Examples of a suitable quaternary amine compound can include, without limitation, bis(hydrogenated tallow alkyl)dimethyl ammonium chloride (Arquad™ 2HT); benzylbis(hydrogenated tallow alkyl)methyl ammonium chloride (Arquad™ M2HTB); benzyl(hydrogenated tallow alkyl)dimethyl ammonium chloride (Arquad™ DMHTB); trihexadecylmethyl ammonium chloride (Arquad™ 316); tallowalkyl trimethyl ammonium chloride (Arquad™ T-27W and Arquad™ T-50); hexadecyl trimethyl ammonium chloride (Arquad™ 16-29W and Arquad™ 16-50); octadecyl trimethyl ammonium chloride (Arquad™ 18-50(m)); dimethylhydrogenated tallow-2-ethylhexyl ammonium methylsulfate; quaternary ammonium ions containing ester linkage as described in U.S. Pat. No. 6,787,592, hereby incorporated by reference; di(ethyl tallowalkylate)dimethyl ammonium chloride (Arquad™ DE-T); quaternary ammonium ions containing amide linkage as described in US patent application 2006/0166840 hereby incorporated by reference; alkoxylated quaternary ammonium chloride compounds as described in U.S. Pat. No. 5,366,647 hereby incorporated by reference; cocoalkylmethylbis(2-hydroxyethyl) ammonium chloride (Ethoquad™ C12); octadecylmethyl[polyoxyethylene(15)] ammonium chloride (Ethoquad™ 8/25); octadecylmethyl (2-hydroxyethyl) ammonium chloride (Ethoquad™ 18/12); N,N,N′,N′,N′-pentamethyl-N-tallowalkyl-1,3-propane diammonium dichloride (Duaquad™ T-50); N-tallow-1,3-diaminopropane (Duomeen™ T); N-tallowalkyl dipropylene triamine (Triameen™ T); and N-tallowalkyl tripropylene tetramine (Tetrameen™ T), and mixtures thereof.

The organoclay can be formed according to known intercalation methods or can be obtained on the retail market. For instance, the sequestering agent can include Organoclay MRM™ (available from CETCO, Hoffman Estates, Ill.) and/or ClayFloc™ 750 (available from Biomin International, Inc., Oak Park, Mich.).

To form the organoclay, standard clay surface modification methods as are generally known in the art may be utilized. For instance, either a wet formation process or a dry formation process may be utilized to form the sequestering agent.

To form the organoclay according to a wet process, the cationic quaternary amine can be introduced into the clay mineral that can be provided in the form of a slurry. The liquid of the slurry can be aqueous and with or without an organic solvent, e.g., isopropanol and/or ethanol, which can aid in dissolving the quaternary amine compound. Prior to addition of the quaternary amine compound, the slurry can include a clay concentration of from about 5 wt. % to about 10 wt. % (about 90-95 wt. % liquid). The quaternary amine compound can be added as a solid to the slurry and following combination of the clay and the quaternary amine compound with the liquid, the slurry can include from about 20 wt. % to about 40 wt. % liquid (i.e., water and/or organic solvent), for instance about 30 wt. % or more liquid, about 30 wt. % to about 40 wt. % liquid, or from about 25 wt. % to about 35 wt. % liquid, based on the dry weight of clay and the quaternary amine compound. A lower amount of liquid in the blend can lead to less water being sorbed by the intercalate, thereby necessitating less drying energy after intercalation. The formed organoclay can be easily separated from the water, since the clay is now hydrophobic, and dried in an oven to less than about 5% water, or less than about 2% water in one embodiment.

In a dry process, the powder form of the clay mineral can be fed into a mixer via a port for solids, typically an extruder. A separate port for a second solid can also be used in addition to the clay feeding port. The liquid forms of the additives, including water, the quaternary amine compound, and any other optional additives, can be fed into the mixer through the separate ports. The solids and/or the liquids can be pre-mixed, either together or separately, before they are fed into the extruder. In general, the liquid weight can be from about 10% to about 50% based on the total mixture weight, for instance from about 20% to about 40%, or from about 25% to about 35%. The mixture from the extruder can be further dried through a dryer and can be ground to the preferred particle size. A screening process can be used to collect the finished product.

The quaternary amine compound (e.g., a chloride salt of the cationic quaternary amine), can generally be combined with the slurry in an amount to provide the desired cation exchange during the intercalation. For instance the quaternary amine compound can be provided at a molar ratio of quaternary amine ions to exchangeable interlayer cations of about 0.5:1 or greater, for instance at about 1:1 or greater. In one embodiment, the cationic quaternary amine can be intercalated within the clay in an excess amount, i.e., greater than about 1:1, such that the organoclay has a positively charged surface. The organoclay can generally include the clay component in an amount of from about 50% to about 90%, from about 35% to about 85%, from about 50% to about 75%, or from about 55% to about 70%, by weight of the organoclay, and can include the cationic quaternary amine intercalate in an amount from about 10% to about 50%, from about 15% to about 45%, from about 20% to about 50%, or from about 25% to about 35%, by weight of the organoclay.

The particle size of the organoclay of the sequestering agent is not particularly limited, though a smaller particle size may be more efficient due to the higher surface area available for contact with the aqueous solution. In one embodiment, the sequestering agent can include organoclay particles with a particle size distribution such that about 80 wt % or more of the organoclay particles can pass through a 20 mesh screen (U.S. Sieve Series; 0.841 mm nominal sieve opening). In another embodiment, about 80% or more by weight of the organoclay particles can pass through a 100 mesh screen (U.S. Sieve Series; 0.149 mm nominal sieve opening).

The sequestering agent can include additional components in conjunction with the organoclay. For instance, the organoclay can be combined with a cationic surfactant such as sodium lauryl sulfate, toluene sulfanoamide, other cationic surfactants, or combinations thereof. The addition of a cationic surfactant to the organoclay can increase the positive charge of the sequestering agent.

In one embodiment, the sequestering agent can include a sulfur-containing compound in conjunction with the organoclay. For instance, the organoclay that incorporates the cationic quaternary amine intercalate can include a second intercalate in the form of elemental sulfur, sulfite, sulfate, sulfide, or polysulfur organic compounds. In one embodiment, the sequestering agent can include a mixture of a first organoclay that incorporates a cationic quaternary amine intercalate and a second modified clay that incorporates a sulfur-containing compound intercalate.

In another embodiment, the organoclay that includes the cationic quaternary amine intercalate can be further reacted with a sulfur-containing coupling agent. In addition, the organoclay that is reacted with a sulfur-containing coupling agent can include the cationic quaternary amine intercalate as the only intercalate or optionally can also include an additional intercalate, e.g., a sulfur-containing intercalate. Such compositions are described in U.S. Pat. Nos. 7,501,992; 7,871,524; 7,553,792; and 8,025,160 to Wang, et al., all of which are incorporated herein by reference.

A clay can be impregnated with a sulfur-containing compound according to standard intercalation methods, for instance via the wet process or the dry process as described above. When incorporating both a cationic quaternary amine and elemental sulfur as co-intercalates, the materials can be impregnated at the same time or sequentially, as desired.

A sulfur-containing coupling agent can generally include mercapto, disulfide, tetrasulfide, or polysulfide reactant group. In addition, the coupling agent can include a functionality for coupling to the organoclay, for instance a silane coupling functional group. Examples of coupling agents can include, without limitation, 3-Mercaptopropyltrimethoxysilane; 3-Mercaptopropyltriethoxysilane; 3-Mercaptopropylmethyldimethoxysilane; (Mercaptomethyl)dimethylethoxysilane; (Mercaptomethyl)methyldiethoxysilane; 11-mercaptoundecyltrimethoxysilane; Bis[3-(triethoxysilyl)propyl]-tetrasulfide; Bis[3-(triethoxysilyl)propyl]-disulfide; Bis-[m-(2-triethoxysily)lethyl)tolyl]-polysulfide; and mixtures thereof.

When utilized, the sulfur containing coupling agent can be combined with the organoclay at the time of intercalation or at a different time, as desired. For instance, following combination mixing under shear of a clay and a quaternary amine compound, the mixture can be combined with the silane agent (e.g., an aqueous solution of the quaternary amine compound, optionally including an amount of an additional solvent, such as ethanol), and mixed under shear to encourage bonding of the coupling agent to the organoclay. The formed composite can be dried, for instance to a moisture content of less than about 5% by weight. When present, an organoclay can include the sulfur containing coupling agent in an amount of about 20% or less by weight of the organoclay, for instance about 15% or less or about 10% or less, in one embodiment.

The sequestering agent can be highly effective in removing highly soluble radioactive anions from an aqueous solution. As utilized herein, the term “high solubility” generally refers to a compound with a solubility of about 0.1 moles/liter or greater. Highly soluble radioactive anions can include, for example, technetium (VII), radioiodine (-I or -V), radioselenium (VI or IV), or anionic complexed species of metals (such as uranium-carbonate (e.g., U(CO3)32-, UO2(CO3)34-)).

The highly soluble radioactive anions can be removed from an aqueous solution through contact with the sequestering agent. For example, the aqueous solution can be contacted with the sequestering agent through a static batch process that can last from minutes to days, depending on the system chemical conditions to encourage sorption of the radioactive anions by the sequestering agent. In one embodiment, the sequestering agent can be provided in a column, and the aqueous solution can flow through the column to contact the sequestering agent. It should be understood, however, that a column separation process is not required, and any contact methodology can be utilized to encourage sorption of the highly soluble radioactive anions by the sequestering agent.

In those embodiments in which the sequestering agent includes multiple components, the aqueous solution can contact the components together or separately. For example, in one embodiment, a sequestering agent can include an organoclay that includes a cationic quaternary amine intercalate and a sulfur-containing coupling agent and can also include a clay that includes a sulfur-containing intercalate that is not necessarily a cationic quaternary amine (e.g., elemental sulfur). In one embodiment, the two components can be mixed and this mixture can contact the aqueous solution that includes the radioactive anions. In another embodiment, the aqueous solution can first contact the organoclay/sulfur-containing coupling agent component and can subsequently contact the sulfur-containing clay component. The order in which the aqueous solution contacts the different components of the sequestering agent is not particularly limited. For instance the aqueous solution can be brought in to contact with the sulfur-containing clay first and can contact the organoclay component subsequent to this initial contact.

When considering groundwater remediation, the process can include pumping the contaminated groundwater through a container (e.g., a column) within which the groundwater can contact the sequestering agent and the highly soluble radioactive anions can be removed from the aqueous solution and sorbed onto the sequestering agent. In another embodiment, the sequestering agent can be injected into the ground through a well and then a “passive reactive barrier” can be formed whereby the contaminant stream hits this reactive barrier, and the targeted anionic radionuclide is removed, while water and non-targeted solutes pass through freely. This in situ immobilization can reduce the mobility of the contaminant.

When considering treatment of a waste stream from a nuclear power generation plant, the method can include pumping the waste stream through a container (e.g., a column) within which the waste stream can contact the sequestering agent and the highly soluble radioactive anions can be removed from the aqueous solution and sorbed onto the sequestering agent.

The method can be highly efficient, for instance concentrating the radioactive anions on the sorbent component(s) of the sequestering agent (i.e., the organoclay and any other sorbent components of the sequestering agent) about 5,000 times or more as compared to the concentration of the radioactive anions in the solution following the contact period. For example, the method can concentrate radioiodide on the sorbent(s) about 5,000 times or more, about 8,000 times or more, about 10,000 times or more, about 20,000 times or more or about 25,000 times or more, with respect to the radioiodine concentrations in the solution (e.g., 5000 pCi radioiodine on the sorbent per one pCi of solution radioiodine in the solution that contacts the sorbent). The method can concentrate radioactive technetium on the sorbent(s) surface about 50,000 times or more, about 70,000 times or more, about 90,000 times or more, about 100,000 times or more or about 110,000 times or more, with respect to the technetium concentrations in the solution (e.g., 5000 pCi radioiodine on the sorbent per one pCi of solution radioiodine in contact with the sorbent).

The present application may be further understood by reference to the following Example.

### Example

Commercially available sequestering agents were utilized as sorbents. Sorbents included Organoclay MRM™ (available from CETCO, Hoffman Estates, Ill.) (Sorbent 1) and ClayFloc™ 750 (available from Biomin International, Inc., Oak Park, Mich.) (Sorbent 2)) As a control, sediment from the Savannah River Site (Sorbent 3) was utilized.

Three experiments were conducted with the sorbents to evaluate how they interact with ⁹⁹TcO₄⁻ and ¹²⁹I⁻. For comparison purposes, ¹³⁷Cs⁺ was also included to provide insight as to how these sorbents interact with a monovalent cation. The three experiments are referred to as the (Ad)sorption Experiment, the Desorption Experiment, and the Proof-of-concept Experiment. The (Ad)sorption Experiment provided a measure of how much radionuclide was bound to the solid sorbent compared to how much remained in solution. The Desorption Experiment evaluated how readily radionuclides would desorb from the sorbents when placed in solution of extreme pH levels, pH 3 and 10. The Proof-of-concept Experiment examined how well the sorbents, when mixed with a Tc-contaminated sediment, reduced the amount of Tc in mobile pore water.

### Materials and Methods

### (Ad)Sorption Experiment:

Batch sorption experiments were set up in 2-4 replicates at a constant concentration for each radionuclide in an artificial groundwater (pH 5.5) solution under ambient temperature (22° C.). For each set of experiments, a solids-free control treatment was included in triplet. The purpose of these controls was to determine the initial radionuclide concentration for K_{d} calculation (described below) and to provide an indication if any radionuclide sorption to the tube walls occurred during the experiment (no loss of radionuclide to the tube walls was noted). About 0.1 g of sorbent and 10 mL artificial groundwater were added into a 15 mL polypropylene centrifuge tube. After spiking 0.1 mL of the stock solution, the initial radionuclide concentration in the working solution was targeted at 5.0×10³ pCi/mL ⁹⁹TcO₄⁻, 500 pCi/mL ¹²⁹I⁻ and 55 or 500 pCi/mL ¹³⁷Cs⁺. The suspensions were placed on a slow moving platform shaker for a 7-day equilibration period. Each suspension was then filtered using 0.2 μm nylon membrane syringe filter. After measuring pH, the filtrate was analyzed for ⁹⁹Tc concentrations using liquid scintillation counting (LSC), for ¹²⁹I by low energy gamma spectrometry, and for ¹³⁷Cs by gamma spectrometry. The extent of the radionuclide sorption to each sorbent was calculated using a distribution coefficient or K_{d} value (mL/g):

$${K}_{d} = \frac{{C}_{solid}}{{C}_{liquid}} \qquad ( 1 )$$

where C_{solid} is the radionuclide concentration associated with the solid (pCi/g) and C_{liquid} is the radionuclide concentration in the groundwater at the end of the solid-liquid equilibration period (pCi/mL).

### Desorption Experiment:

To evaluate the effect of more extreme pH values on the desorption of the radionuclides from the sorbents, artificial groundwater was pH adjusted to 3 or 10 and added to the sorbents after completing the (Ad)sorption Experiment described above. About 10 mL of pH-adjusted artificial groundwater was added as a leaching solution. The suspensions were adjusted again to the targeted pH values. The suspensions were placed on a slow-moving platform shaker for additional 7 days to reach a second equilibration. After measuring the suspension pH, each suspension was filtered using 0.2-μm Nylon membrane syringe filters. The filtrate was analyzed for ⁹⁹Tc, ¹²⁹I, and ¹³⁷Cs concentrations using the same analytical methods as used for the (Ad)sorption Experiment. The desorption percentage was calculated based on the radionuclide mass in the desorption solution (M_{D}) and radionuclide mass associated with the solids (M_{S}):

$$\% Radionuclide desorbed = \frac{{M}_{D}}{{M}_{S}} \times 100 \qquad ( 2 )$$

### Proof-of-Concept Experiment:

The objective of this experiment was to evaluate the impact of sorbent concentration on radionuclide uptake from Tc-amended sediment. Duplicate batch tests were established by combining 20-g dry weight sediment, 20 mL of 5 mg/L NH₄⁺ (added as NH₄NO₃) in AGW solution, and 0, 0.1 or 1 g of each sorbent. The final sorbent concentrations were 0%, 0.5%, or 5%, with respect to sediment dry weight. The no-amendment sediment treatments provided a measure of the total amount of mobile Tc released into the aqueous phase. The suspensions were placed on a shaker for 7 days. Each suspension was filtered using 0.45 μm Nylon membrane syringe filters. After measuring pH, the filtrate was analyzed for ⁹⁹Tc using low-energy gamma spectroscopy.

### Results

### (Ad)Sorption Experiment:

The concentration ratio of radionuclide on the sorbent versus in solution, that is the K_{d} value, (Equation 1) is presented in Table 1, below. Also presented is the typical K_{d} value of the Tc, I, and Cs in typical Savannah River Site (SRS) sediments. The Tc, I, and Cs K_{d} values for both organoclays were extremely high, several orders of magnitude greater than those of the SRS sediments. These high K_{d} values indicate that much more radionuclide was associated with the sorbents than the aqueous phase.

TABLE 1

| | Batch for Tc spiking | | Batch for I and Cs spiking | | |
|---|---|---|---|---|---|
| | | ⁹⁹Tc K_{d} | | ¹²⁹I K_{d} | ¹³⁷Cs K_{d} |
| Sorbents | PH | (mL/g) | PH | (mL/g) | (mL/g) |
| ClayFloc ™ | 10.5 | >117,000 ± | 10.5 | >9,610 ± | 2,800 ± |
| 750 | | 7,000 | | 630 | 570 |
| Organoclay | 3.5 | >112,000 ± | 3.5 | >29,300 ± | 1,230 ± |
| MRM ™ | | 1,000 | | 400 | 110 |
| SRS sediments | 5.5 | 0.6-1.8 | 5.5 | 0.3-0.9 | 10-50 |

^{(a)} Experimental conditions included: 2-4 replicates, ambient temperature, 10 g/L sorbent in artificial groundwater, initial spike concentrations of 5.0 × 10³ pCi/mL ⁹⁹TcO₄⁻, 500 pCi/mL ¹²⁹I⁻, and 50 pCi/mL ¹³⁷Cs⁺, 7-day contact time, phase separation by settling and 0.20-μm filter.

### Desorption Experiment:

Results from the Desorption Experiment are presented in Table 2. In this study, the sorbents, after they were used to generate the data in Table 1 (the (ad)sorption K_{d} values), were placed in solutions of extreme pH values, pH 3 and 10. Both sorbents were highly effective at retaining ⁹⁹Tc, irrespective of pH. Also, ¹²⁹I did not desorb greatly at elevated pH levels from the sorbents. However, a significant amount of ¹²⁹I desorbed at lower pH levels. This suggests that the sorbents for ¹²⁹I would be less effective under low pH conditions than higher pH conditions.

TABLE 2

| | Initial Leach- | % Tc | % I | % Cs |
|---|---|---|---|---|
| Sorbent | ate PH | Desorption | Desorption | Desorption |
| ClayFloc ™ | 3 | 0.2 | 41.8 | 3.9 |
| 750 | 10 | 0.1 | 0.9 | 3.0 |
| Organoclay | 3 | 0.1 | 8.5 | 3.6 |
| MRM ™ | 10 | 0.1 | 7.6 | 3.5 |

### Proof-of-Concept Experiment:

The results from the Proof-of-concept Experiment are presented in FIG. 1. In addition to testing the ClayFloc™ 750 (Sorbent #2 in FIG. 1) and Organoclay MRM™ (Sorbent #3 in FIG. 1), two other sorbents were included in the test for comparison purposes including activated carbon (GAO 830; Sorbent #1 in FIG. 1) and surfactant modified chabazite (Sorbent #4 in FIG. 1). Without any sorbent added to the Tc-contaminated sediment (Sorbent #1), the ⁹⁹Tc concentrations were 541 dpm/mL. Upon adding 0.5 or 5 wt % ClayFloc™ 750 or Organoclay MRM™, the ⁹⁹Tc pore water concentrations decreased to below detection limits. This indicates that upon the addition of these sorbents to the Tc-contaminated sediment, that the ⁹⁹Tc became immobilized, even at amendment concentrations as low as 0.5%, and the ⁹⁹Tc would be less mobile in the environment.

### CONCLUSIONS

Both tested sorbents, ClayFloc™ 750 and Organoclay MRM™ were extremely effective at sorbing ⁹⁹TcO₄⁻ and ¹²⁹I⁻ under oxidizing conditions. These sorbents can be used to remove these difficult to separate radionuclides from the aqueous phase, with applications to chemical engineering, nuclear engineering, medicine, and environmental remediation.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A method for removing highly soluble radioactive anions from an aqueous solution comprising contacting the aqueous solution with a sequestering agent, the aqueous solution including the highly soluble radioactive anions, the sequestering agent including an organoclay, the organoclay comprising a clay and/or a clay mineral, the sequestering agent further comprising a cationic quaternary amine within and/or on the surface of the clay, wherein the radioactive anions are adsorbed on the organoclay following contact of the aqueous solution with the sequestering agent.

2. The method of claim 1, wherein the concentration of the radioactive anions on the organoclay is about 5,000 times or more greater than the concentration of the radioactive anions in the aqueous solution following the contact of the aqueous solution with the sequestering agent.

3. The method of claim 1, wherein the highly soluble radioactive anions comprise radioactive technetium.

4. The method of claim 3, wherein the concentration of the radioactive technetium on the organoclay is about 50,000 times or more greater than the concentration of the radioactive technetium in the aqueous solution following the contact of the aqueous solution with the sequestering agent.

5. The method of claim 1, wherein the highly soluble radioactive anions comprise radioactive iodine.

6. The method of claim 5, wherein the concentration of the radioactive iodine on the organoclay is about 8,000 times or more greater than the concentration of the radioactive iodine in the aqueous solution following the contact of the aqueous solution with the sequestering agent.

7. The method of claim 1, wherein the clay and/or clay mineral comprises a phyllosilicate.

8. The method of claim 7, wherein the clay and/or clay mineral comprises a hydrous aluminum phyllosilicate.

9. The method of claim 1, wherein the clay and/or clay mineral comprises a zeolite.

10. The method of claim 1, wherein the cationic quaternary amine has the general structure of: 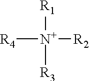
wherein R₁, R₂, R₃, and R₄ are independently hydrogen or hydrocarbon groups including from about 1 to about 24 carbons and include linear, branched, and/or aromatic moieties, and that can be substituted or non-substituted, with the proviso that not all of R₁, R₂, R₃, and R₄ are hydrogen.

11. The method of claim 10, wherein the cationic quaternary amine includes a sulfur-, iron-, or nitrogen-containing organic group as at least one of R₁, R₂, R₃, and R₄.

12. The method of claim 1, wherein the organoclay includes the clay and/or clay mineral in an amount of from about 50% to about 90% by weight of the organoclay.

13. The method of claim 1, wherein the organoclay includes the cationic quaternary amine in an amount from about 10% to about 50% by weight of the organoclay.

14. The method of claim 1, the organoclay having a particle size with a particle size distribution such that about 80% or more by weight of the organoclay can pass through a 20 mesh screen (U.S. Sieve Series).

15. The method of claim 1, the sequestering agent further comprising a cationic surfactant.

16. The method of claim 1, the sequestering agent further comprising a sulfur-containing compound.

17. The method of claim 16, wherein the sulfur-containing compound is an intercalate of the organoclay.

18. The method of claim 16, wherein the sequestering agent comprises a second modified clay and/or clay mineral that incorporates the sulfur-containing compound.

19. The method of claim 1, the organoclay further comprising a sulfur-containing coupling agent that is adhered to the organoclay.

20. The method of claim 1, wherein the aqueous solution comprises contaminated groundwater.

21. The method of claim 20, wherein the aqueous solution is injected into the ground to contact the groundwater.

22. The method of claim 1, wherein the aqueous solution is a waste stream.

23. The method of claim 22, wherein the aqueous solution is a waste stream from a nuclear power generation plant.
